(19) United States
(12) Patent Application Publication
(10) Pub. No.: US 2016/0089694 A1
(43) Pub. Date: Mar. 31, 2016

(54) ARTISTIC NAIL POLISH CURING APPARATUS

(71) Applicant: PRIOR COMPANY LIMITED, TAIPEI CITY (TW)

(72) Inventor: ERIC JIH, NEW TAIPEI CITY (TW)

(21) Appl. No.: 14/499,779

(22) Filed: Sep. 29, 2014

(51) Int. Cl. B05D 3/06; A45D 29/18

(52) U.S. Cl. CPC B05D 3/067; A45D 29/18

(57) ABSTRACT

An artistic nail polish curing apparatus includes a casing, a lamp holder, a light curing lamp module, a lamp source and a control unit. During use, a switch is assembled for turning on/off a lamp source to emit light, and a casing cover is formed at an opening at the top of the casing for selectively transmitting the light to the outside and allowing users to judge the ON/OFF status of the curing apparatus, while maintaining the overall stylish design of the curing apparatus.

### FIELD OF THE INVENTION

The present invention relates to a nail cosmetic apparatus, in particular to an artistic nail polish curing apparatus.

### BACKGROUND OF THE INVENTION

With reference to FIG. 4 for a conventional curing apparatus, the conventional curing apparatus comprises a casing 91, a through hole 92 formed on a side of the casing 91, a chamber 93 formed in the casing 91 and interconnected with the through hole 92, and a light curing lamp (not shown in the figure) installed in the chamber 93. Before use the curing apparatus, a user extends a finger with an artistic nail polish from the through hole 92 into the chamber 93, and presses a press button 94 installed on a surface of the casing 91 to turn on the light curing lamp in the chamber 93, so as to cure the artistic nail polish by ultraviolet light.

However, the aforementioned conventional curing apparatus has the following problems:

1. When the conventional curing apparatus is used, the surface of the casing 91 does not have the function of showing the ON/OFF status of the curing apparatus, so that users do not know from the external appearance of the casing 91 whether or not the curing apparatus is turned on, and the users can just determine the status by checking whether there is any ultraviolet light leaking from the through hole 92. However, the ultraviolet light is harmful to the users' eyes, so that the casing 91 generally includes a canopy 95 installed on a side of the through hole 92 for blocking the ultraviolet light during the process of curing the nail polish. Checking the ultraviolet light to determine the ON/OFF status of the curing apparatus may result in unnecessary harms to the users' eyes.

Although an indicating lamp may be installed to the casing 91 to determine the ON/OFF status of the curing apparatus, the conventional curing apparatuses available in the market have a high requirement on the stylish design of the appearance of the curing apparatus. Therefore, the installation of the indicating lamp may ruin the overall stylish design of the casing 91 and fail to meet the design requirements, and thus is not conducive to the market competition. Therefore, almost all of the curing apparatuses available in the market do not come with an indicating lamp.

2. In the conventional curing apparatus, the press button 94 is generally a mechanical press button, so that the press button 94 is usually protruded from the casing of the curing apparatus, and the curing apparatus is turned on or off by pressing the press button 94 by a finger. When the user presses the press button 94 with a finger painted with the artistic nail polish, the nail polish painted on the user's finger may touch the casing by accident and ruin the external appearance of the casing. As a result, it is necessary for the user to paint the artistic nail polish again.

### SUMMARY OF THE INVENTION

Therefore, it is a primary objective of the present invention to overcome the aforementioned problems of the prior art by providing an artistic nail polish curing apparatus, so that the ON/OFF status of the curing apparatus may be determined by checking whether or not there is any light of a lamp source coming out from the casing cover without requiring to check the ultraviolet light, so as to prevent unnecessary harms to the eyes and maintains the overall stylish design of the curing apparatus.

Another objective of the present invention is to provide a touch (or a non-pressing type) s witch for the light curing lamp module and the lamp source, so that a user may touch a touch portion to turn on or off the light curing lamp module and the lamp source, so as to prevent the nail polish from ruining the overall appearance of the casing if the user has to press the press button by the finger.

To achieve the aforementioned objectives, the present invention provides an artistic nail polish curing apparatus, comprising:

a casing, with a stylish design, and having a through hole formed on a side of the casing, an opening formed at the top of the casing, and an opaque but translucent casing cover, and the casing cover constituting said portion of the stylish design and covered onto the opening; a lamp holder, installed in the casing, and lamp holder being hollow and having a chamber formed in the casing, and the chamber being hollow at a side of the through hole and interconnected to the through hole; a light curing lamp module, fixed in the lamp holder, and provided for irradiating ultraviolet light to the chamber; a lamp source, installed in the casing, and disposed at the opening, and aligned precisely with the casing cover; and a control unit, installed in the casing, and electrically coupled to the light curing lamp module and the lamp source, and the casing being electrically coupled to a switch for turning on or off the light curing lamp module and the lamp source.

The translucent casing cover includes a display portion with a relatively high light transmittance. The display portion includes a text, a graphic, or a combination of the text and graphic.

The switch includes a capacitive touch circuit board installed in the casing and electrically coupled to the control unit, a touch portion exposed from the casing, and a conductor installed between the capacitive touch circuit board and the touch portion, and the touch portion is touched to trigger the capacitive touch circuit board through the conductor to transmit a signal to the control unit to turn on or off the light curing lamp module and the lamp source.

The lamp source includes a plurality of light emitting diodes and a circuit board, and the plurality of light emitting diodes are installed on the circuit board, and the circuit board is installed at the top of the lamp holder.

The lamp holder includes a roof and a sidewall disposed around the periphery of the roof, and the light curing lamp module includes a cold cathode fluorescent lamp installed in the lamp holder and disposed at the roof for irradiating ultraviolet light, and a plurality of light emitting diodes installed in the lamp holder and disposed on the sidewall for irradiating ultraviolet light.

### BRIEF DESCRIPTION OF THE DRAWINGS

FIG. 1 is a perspective view of the present invention;

FIG. 2 is an exploded view of the present invention;

FIG. 3 is a cross-sectional view of the present invention; and

FIG. 4 is a perspective view of a conventional curing apparatus.

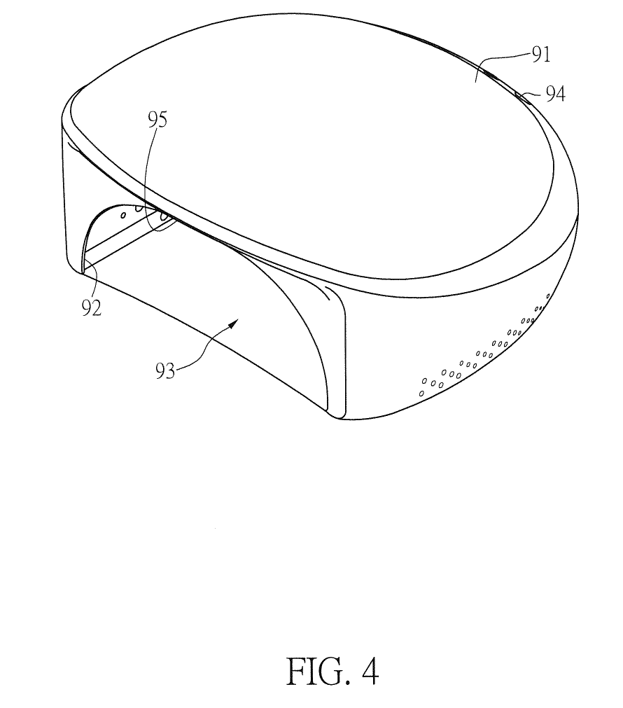

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

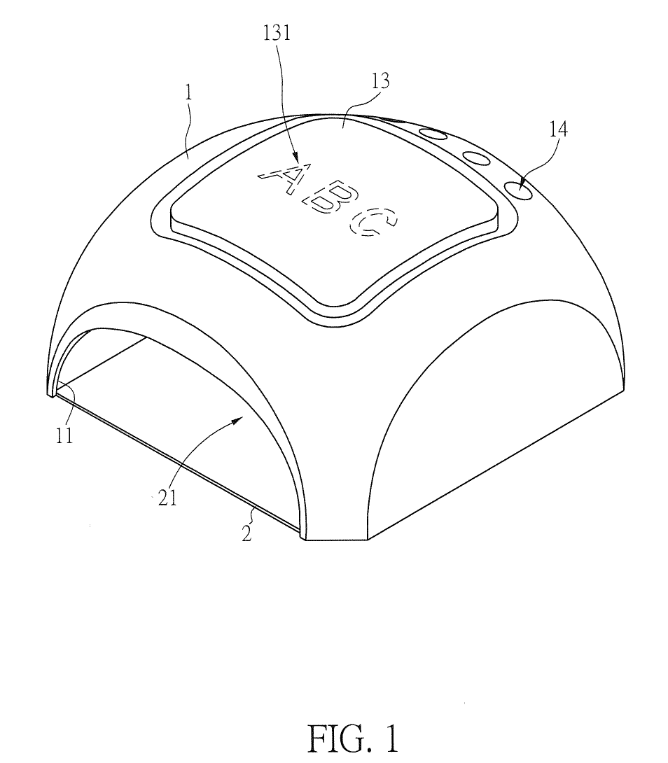

With reference to FIGS. 1 to 3 for an artistic nail polish curing apparatus in accordance with a preferred embodiment of the present invention, the artistic nail polish curing apparatus comprises a casing 1, a lamp holder 2, a light curing lamp module 3, a lamp source 4 and a control unit 5.

The casing 1 comes with an overall stylish design and includes a through hole 11 formed on a side of the casing 1, an opening 12 formed at the top of the casing 1, and a casing cover 13, wherein the casing cover 13 is opaque but translucent and covered onto the opening 12, and the casing cover 13 forming a part of the aforementioned stylish design is covered onto the opening 12. In this preferred embodiment, the translucent casing cover 13 has a display portion 131 with a light transmittance relatively higher than the overall light transmittance of the casing cover 13. In this preferred embodiment, the display portion 131 is a text. In different embodiments, the display portion 131 may be a graphic or a combination of text and graphic.

The aforementioned stylish design refers to the design of the appearance of an object that attracts the attention of consumers. For instance, the casing 1 of this preferred embodiment is a combination of arc surfaces and planes to form the shape of a canopy, and the opening 12 is formed in a shape corresponsive to the shape of the top of the casing 1, so that the casing cover 13 can be covered onto the opening 12, and the casing cover 13 is a part of the stylish design after it is covered onto the opening 12.

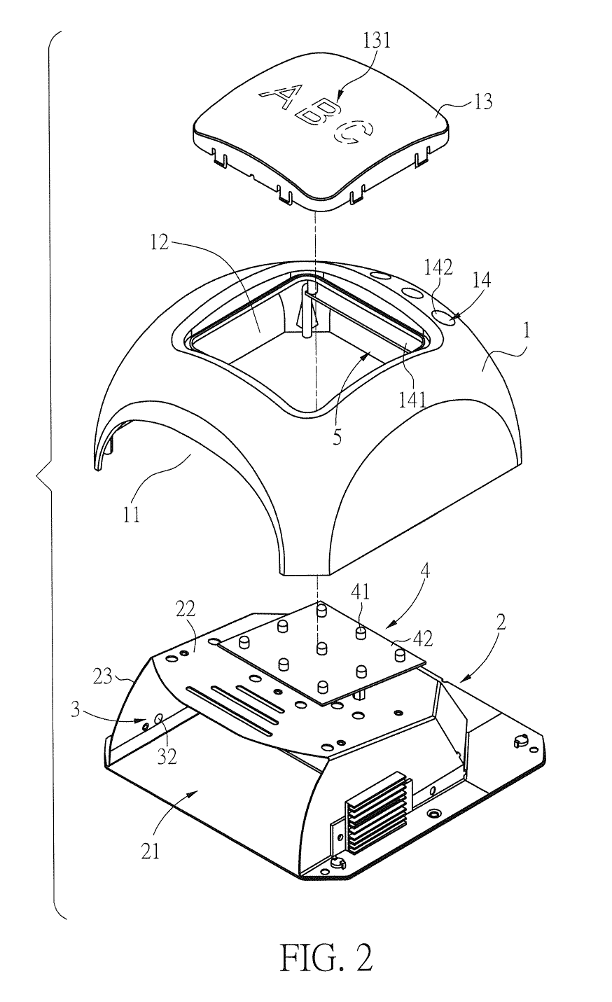

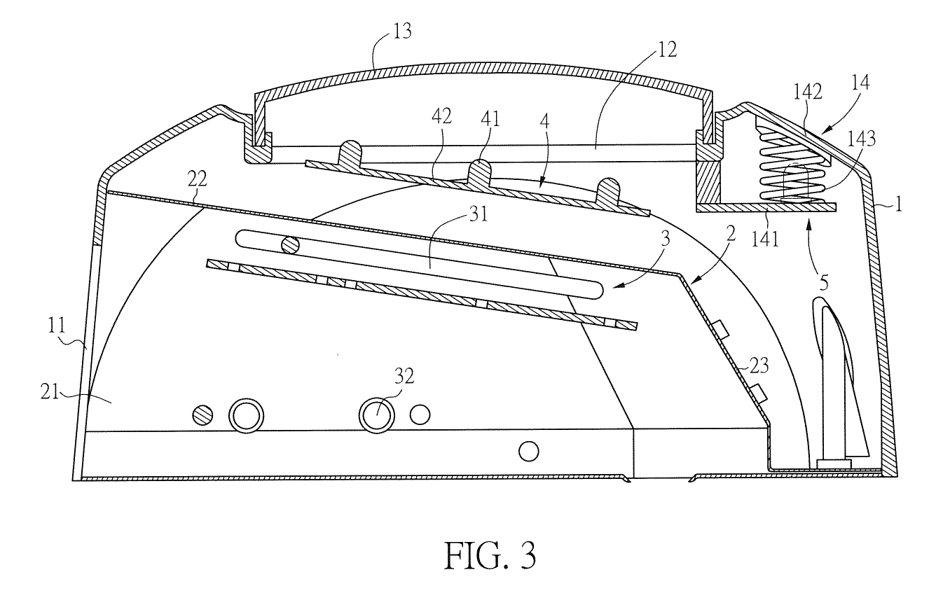

In FIGS. 2 and 3, the lamp holder 2 is installed in the casing 1, and the lamp holder 2 is hollow and a chamber 21 is formed in the casing 1. The chamber 21 is hollow on a side of the through hole 11 and interconnected to the through hole 11. In this preferred embodiment, the lamp holder 1 includes a roof 22 and a sidewall 23, and the sidewall 23 is disposed around the periphery of the roof 22.

In FIGS. 2 and 3, the light curing lamp module 3 is fixed in the lamp holder 2 for irradiating ultraviolet light to the chamber 21. In this preferred embodiment, the light curing lamp module 3 includes a cold cathode fluorescent lamp 31 installed at the roof 22 inside the lamp holder 2 for irradiating ultraviolet light, and a plurality of light emitting diodes 32 installed on the sidewall 23 inside the lamp holder 2 for irradiating ultraviolet light.

In FIGS. 2 and 3, the lamp source 4 is installed in the casing 1 and disposed at the opening 12 and aligned precisely with the casing cover 13. In this preferred embodiment, the lamp source 4 includes a plurality of light emitting diodes 41 and a circuit board 42, wherein the plurality of light emitting diodes 41 are installed on the circuit board 42, and the circuit board 42 is installed at the top of the lamp holder 2.

In FIGS. 2 and 3, the control unit 5 is installed in the casing 1 and electrically coupled to the light curing lamp module 3 and the lamp source 4, and the control unit 5 in the casing 1 is electrically coupled to a switch 14 which is provided for turning on or off the light curing lamp module 3 and the lamp source 4. In this preferred embodiment, the switch 14 includes a capacitive touch circuit board 141, a touch portion 142 and a conductor 143, wherein the capacitive touch circuit board 141 is installed in the casing 1 and electrically coupled to the control unit 5, and the conductor 143 of this preferred embodiment is a spring. The touch portion 142 is exposed from the casing 1, and the conductor 143 is installed between the capacitive touch circuit board 141 and the touch portion 142, so that a user may touch the touch portion 142 to trigger the capacitive touch circuit board 141 by the conductor 143 to transmit a signal to the control unit 5 in order to turn on or off the light curing lamp module 3 and the lamp source 4.

In an actual operation of the artistic nail polish curing apparatus of this preferred embodiment, a user stretches a hand and fingers with an artistic nail polish from the through hole 11 of the casing 1 into the chamber 21 of the lamp holder 2 and touches the touch portion 142 to turn on both of the light curing lamp module 3 and the lamp source 4. Now, the cold cathode fluorescent lamp 31 and the plurality of light emitting diodes 32 start irradiating ultraviolet light to the chamber 21 to cure the nail polish painted on the user's nail. In the meantime, the light emitting diodes 41 of the lamp source 4 are lit when the touch portion 142 is touched. The light emitted from the light emitting diodes 41 passes through the casing cover 13, and becomes obvious particularly when the display portion 131 has a relatively higher light transmittance. If the light emitting diodes 41 are not lit, the display portion 131 will not be seen easily as shown in FIG. 1. FIG. 1 simply shows the position of the display portion 131. It is noteworthy that the display portion will be displayed at the casing cover 13 clearly when the light emitting diodes 41 emit bright light.

In summation of the description above, the present invention has the following advantages:

1. The casing cover 13 is installed while maintaining the stylish design of the curing apparatus. If a user wants to confirm the ON/OFF status of the curing apparatus, the user will not need to check whether there is any ultraviolet light coming out from the through hole 11, but directly determine the ON/OFF status by checking whether there is any light coming out from the casing cover 13. The status can be seen clearly when there is a display portion 131, so that the user can determine the status without the need of looking at the ultraviolet light directly to prevent the ultraviolet light from harming the user's eyes. In addition, the present invention breaks through the design of installing the protruding indicating lamp on the casing which is incompliance with the design requirements, and maintains the integrity of the overall artistic design of the curing apparatus.

2. In general, the curing apparatus is used after the user's fingers are painted with the artistic nail polish, so that the user simply touch the touch portion 142 by any part of the finger other than the nail in order to turn on the light curing lamp module 3. In other words, the user having fingers of one or both hands painted with the nail polish no longer have to worry about the nail polish that may ruin the stylish design or external appearance of the casing. The switch 14 is a touch switch instead of a press switch, so that there is no issue of running the casing by the nail polish when the user is pressing the switch 14. In addition, the user can determine the ON/OFF status of the curing apparatus by checking whether or not there is any bright light coming out from the casing cover 13.

1. An artistic nail polish curing apparatus, comprising:
a casing, with a stylish design, and having a through hole formed on a side of the casing, an opening formed at the top of the casing, and an opaque but translucent casing cover, and the casing cover constituting said portion of the stylish design and covered onto the opening;
a lamp holder, installed in the casing, and lamp holder being hollow and having a chamber formed in the casing, and the chamber being hollow at a side of the through hole and interconnected to the through hole;
a light curing lamp module, fixed in the lamp holder, and provided for irradiating violet light to the chamber;
a lamp source, installed in the casing, and disposed at the opening, and aligned precisely with the casing cover; and
a control unit, installed in the casing, and electrically coupled to the light curing lamp module and the lamp source, and the casing being electrically coupled to a switch for turning on or off the light curing lamp module and the lamp source.

2. The artistic nail polish curing apparatus of claim 1, wherein the translucent casing cover includes a display portion with a relatively high light transmittance.

3. The artistic nail polish curing apparatus of claim 2, wherein the display portion includes a text, a graphic, or a combination of the text and graphic.

4. The artistic nail polish curing apparatus of claim 1, wherein the switch includes a capacitive touch circuit board installed in the casing and electrically coupled to the control unit, a touch portion exposed from the casing, and a conductor installed between the capacitive touch circuit board and the touch portion, and the touch portion is touched to trigger the capacitive touch circuit board through the conductor to transmit a signal to the control unit to turn on or off the light curing lamp module and the lamp source.

5. The artistic nail polish curing apparatus of claim 4, wherein the conductor is a spring.

6. The artistic nail polish curing apparatus of claim 1, wherein the lamp source includes a plurality of light emitting diodes and a circuit board, and the plurality of light emitting diodes are installed on the circuit board, and the circuit board is installed at the top of the lamp holder.

7. The artistic nail polish curing apparatus of claim 1, wherein the lamp holder includes a roof and a sidewall disposed around the periphery of the roof, and the light curing lamp module includes a cold cathode fluorescent lamp installed in the lamp holder and disposed at the roof for irradiating ultraviolet light, and a plurality of light emitting diodes installed in the lamp holder and disposed on the sidewall for irradiating ultraviolet light.
